(19) United States
(12) Patent Application Publication
(10) Pub. No.: US 2012/0267351 A1
(43) Pub. Date: Oct. 25, 2012

(54) METHOD FOR DICING WAFER STACK

(76) Inventor: Shih-Tsun HUANG, Taichung City (TW)

(21) Appl. No.: 13/114,711

(22) Filed: May 24, 2011

(30) Foreign Application Priority Data
Apr. 21, 2011 (TW) 100113912

(51) Int. Cl. B23K 26/00

(52) U.S. Cl. 219/121.72

(57) ABSTRACT

A method for dicing a wafer stack having a first wafer and a second wafer stacked under the first wafer includes the steps of cutting the first wafer by a cutting blade to form a first cutting location on the first wafer, then cutting the first wafer by a laser stealth dicing process to form a second cutting location on the first wafer, and then removing the portion defined by the first and second cutting locations. In this way, it can avoid the to-be-removed portion from flying off from the first wafer during cutting.

### BACKGROUND OF THE INVENTION

1. Field of the Invention

The present invention relates generally to a method for dicing wafer and more particularly, to a method for dicing a wafer stack which can prevent the to-be-removed portion from flying off during cutting.

2. Description of the Related Art

FIG. 1A and FIG. 1B are schematic drawings showing steps of a conventional method for dicing a wafer stack according to a prior art. As shown in FIG. 1A, a wafer stack composed of a first wafer 10 and a second wafer 20 stacked under the first wafer 10 is cut by a cutting blade 14 twice at two different locations for removing the undesired portion 102 from the first wafer 10. Thereafter, as shown in FIG. 1B, the second wafer 12 is further cut by the cutting blade 14 to form a plurality of chips 16.

In the above-mentioned method of prior art, the to-be-removed, undesired portion 102 of the first wafer 10 tends to fly off from the first wafer 10 during the secondary cutting of the first wafer 10 using the cutting blade 14, resulting in that the cutting blade 14 may be broken, the surface of wafer may be scratched and the solder pads 18 between the first and second wafers 10 and 12 may be damaged due to the possible hit of the flying cutting chips, which may in turn adversely affect the quality of wire bounding and the package yield of the product in the sequent processing.

### SUMMARY OF THE INVENTION

The present invention has been accomplished in view of the above-noted circumstances. It is therefore one objective of the present invention to provide a method for dicing a wafer stack, which can prevent the to-be-removed portion from flying off so as to avoid the damage of the wafer and to enhance the package yield of the product.

To achieve the above-mentioned objective, a method for dicing a wafer stack provided by the present invention comprises the steps of a) providing a first wafer and a second wafer stacked under the first wafer; b) cutting the first wafer by using a cutting blade to form a first cutting location on the first wafer; c) cutting the first wafer by a stealth dicing process using a laser cutting machine to form a second cutting location on the first wafer in a way that the second cutting location is spaced from the first cutting location and a to-be-removed portion is defined between the first and second cutting locations; d) removing the to-be-removed portion from the first wafer by breaking the to-be-removed portion at the second cutting location, and e) cutting the second wafer by using the blade to form a plurality of chips. In the method provided by the present invention, a secondary cutting is carried out by a so-called ‘stealth dicing’ process performed by a laser cutting machine to ensure that the to-be-removed portion of the first wafer will not fly off after completion of the two cutting processes of the first wafer. Therefore, it can effectively prevent the cutting equipment and/or semiconductor chips from hitting by cutting chips so as to enhance the package yield of the product.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A and FIG. 1B are schematic drawings showing steps of a method for dicing a wafer stack according to a prior art;

FIG. 2A and FIG. 2B are schematic drawings showing steps of a method for dicing a wafer stack according to a first preferred embodiment of the present invention;

FIG. 3A and FIG. 3B are schematic drawings showing steps of a method for dicing a wafer stack according to a second preferred embodiment of the present invention, and

FIG. 4A and FIG. 4B are schematic drawings showing steps of a method for dicing a wafer stack according to a third preferred embodiment of the present invention.

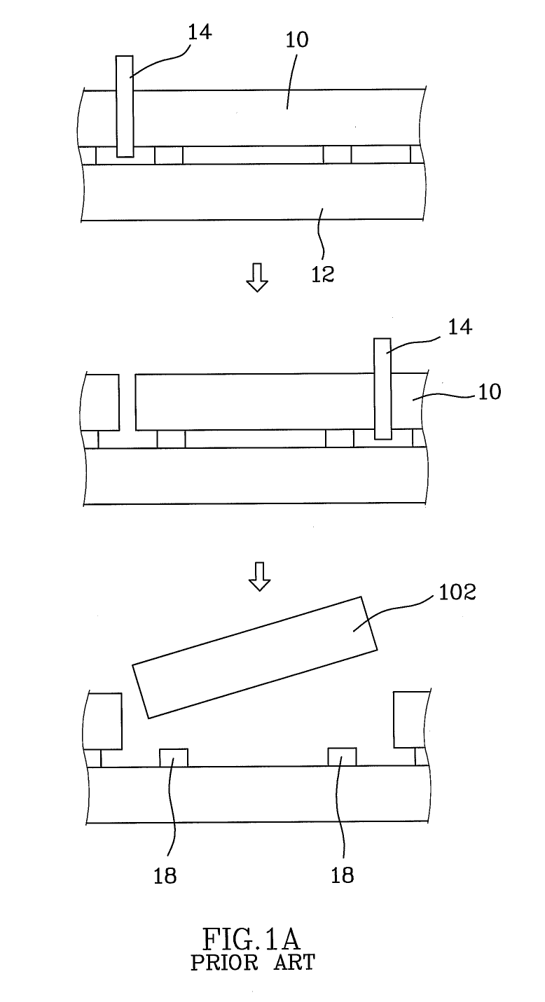

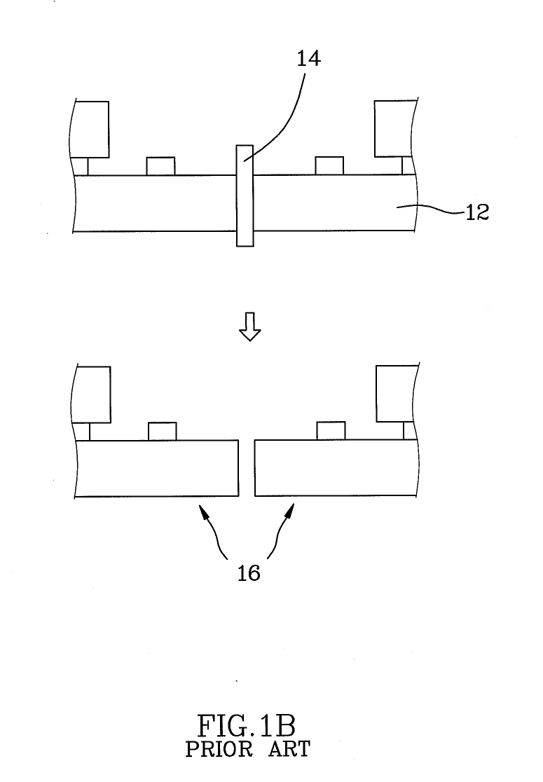

### DETAILED DESCRIPTION OF THE INVENTION

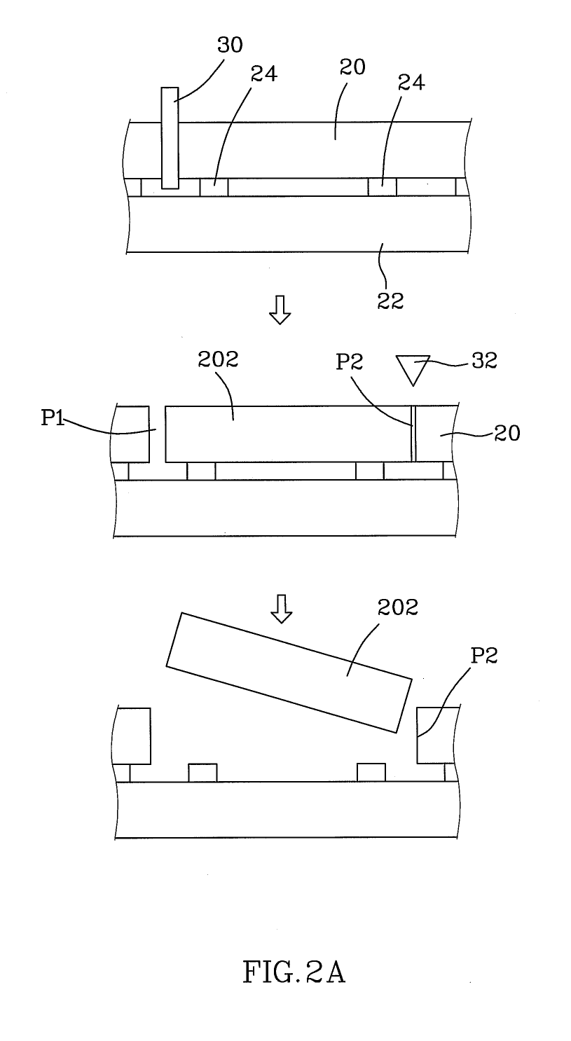

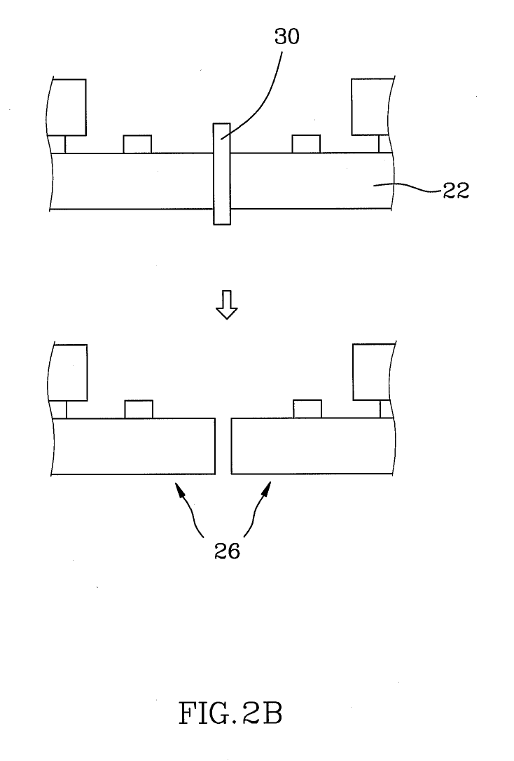

As shown in FIGS. 2A and 2B, a method provided by a first preferred embodiment of the present invention for dicing a wafer stack comprises the following steps.

a) Provide a wafer stack composed of a first wafer 20 and a second wafer 22 stacked under the first wafer 20 and provided with a plurality of solder pad 24 under the first wafer 20. In this preferred embodiment of the present invention, the first wafer 20 is a micro-electro-mechanical systems (MEMS) wafer and the second wafer 22 is a complementary metal-oxide-semiconductor (CMOS) wafer.

b) Use a cutting blade 30 to cut the first wafer 20 to form a first cutting location P1 on the first wafer 20.

c) Use a laser cutting machine 32 to cut the first wafer 20 by performing a stealth dicing process so as to form a second cutting location P2 on the first wafer 20 in such a way that the second cutting location P2 is spaced from the first cutting location P1 at a predetermined distance and a to-be-removed portion 202 is defined between the first cutting location P1 and the second cutting location P2.

d) Use tweezers (not shown in the drawings) to clamp an edge of the to-be-removed portion 202 through the first cutting location P1 and then bend the second cutting location P2 upward to break the to-be-removed portion 202 at the second cutting location P2 so as to remove the to-be-removed portion 202 from the first wafer 20.

e) Use the cutting blade 30 to cut the second wafer 22 to form a plurality of chips 26.

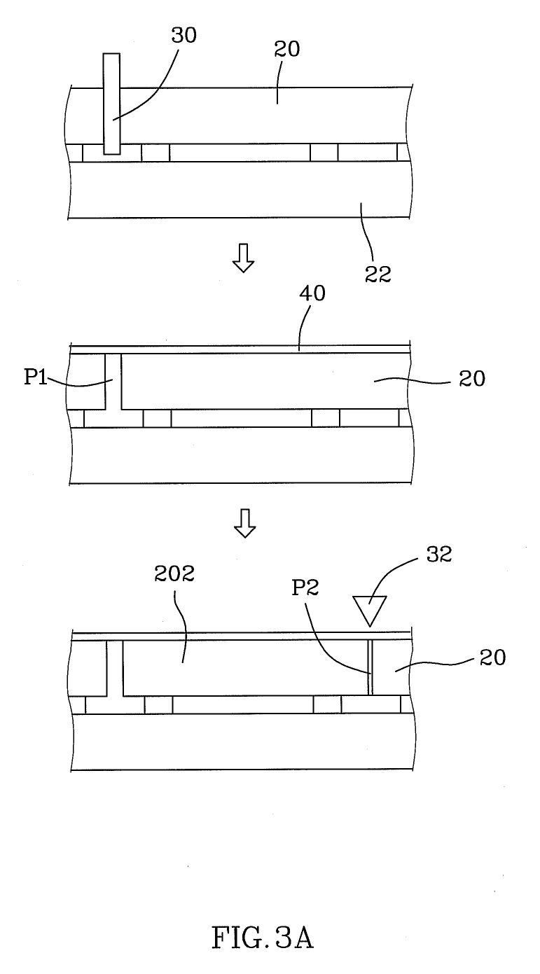

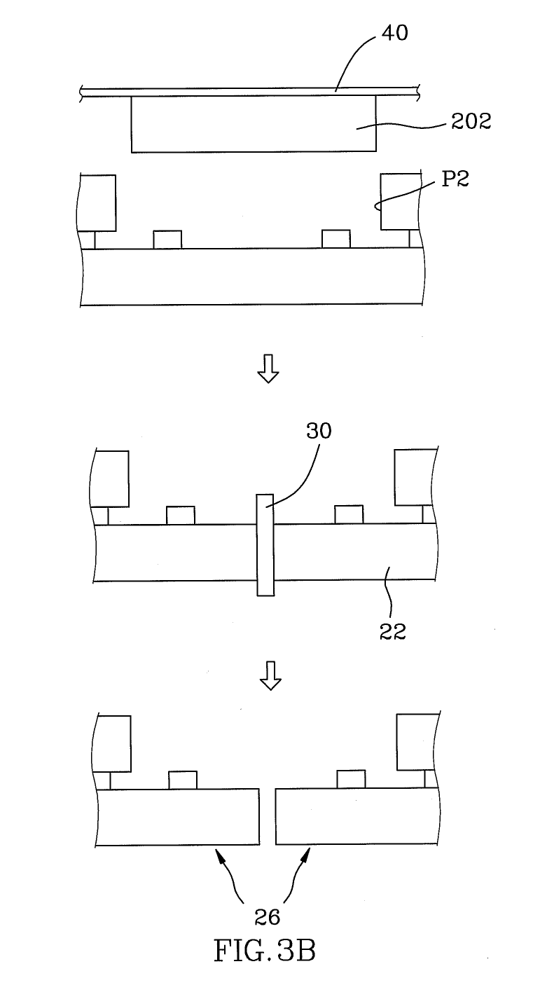

FIG. 3A and FIG. 3B show the steps of a method for dicing a wafer stack according to a second preferred embodiment of the present invention, which differs from the method disclosed in the first preferred embodiment in that an adhesive tape is used for removal of the to-be-removed portion. The steps of the method provided according to the second preferred embodiment of the present invention are recited hereunder.

a) First, a wafer stack composed of a first wafer 20 and a second wafer 22 stacked under the first wafer 20 is provided.

b) Secondly, the first wafer 20 is cut by a cutting blade 30 such that a first cutting location P1 is formed on the first wafer 20, and then an adhesive tape 40 is adhered on the top surface of the first wafer 20.

c) Thirdly, the first wafer 20 is cut by a stealth dicing process using a laser cutting machine 32 such that a second cutting location P2 is formed on the first wafer 20.

d) Fourthly, the adhesive tape 40 is peeled off from the first wafer 20 in such a way that the to-be-removed portion 202 is bent and broken at the second cutting location P2 and then removed along with the peeled adhesive tape 40.

e) Finally, the second wafer 22 is cut by a cutting blade 30 such that a plurality of chips 26 are formed.

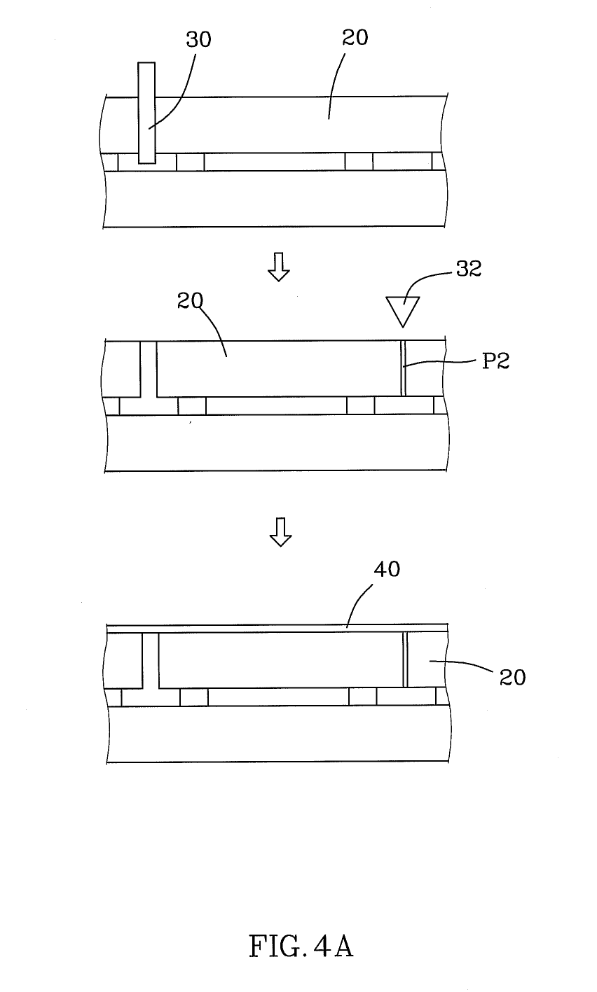

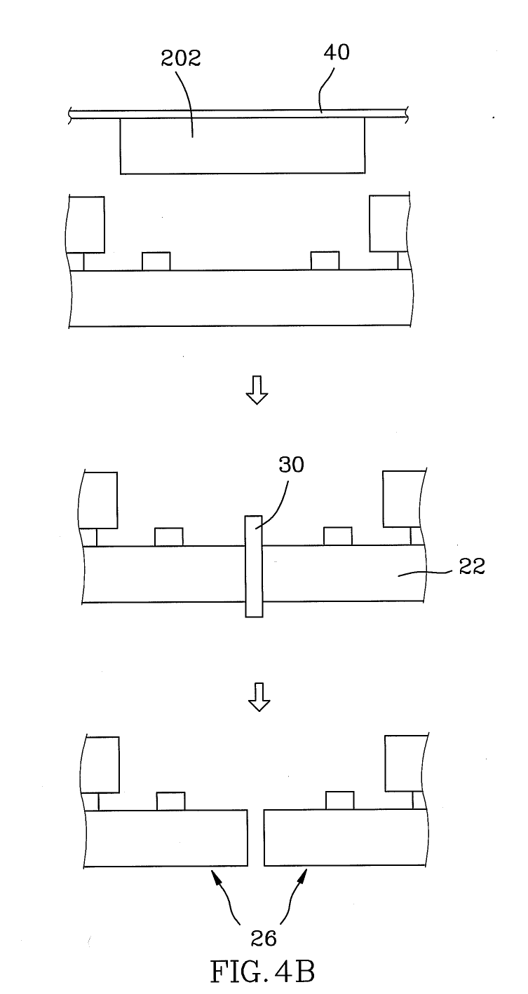

Referring to FIGS. 4A and 4B which show the steps of a method for dicing a wafer stack according to a third preferred embodiment of the present invention, the difference between the methods disclosed by the second and third preferred embodiments lies in that the time at which the adhesive tape 40 is adhered on the first wafer 20 is different. Specifically speaking, as shown in FIG. 4A, the adhesive tape 40 is adhered on the top surface of the first wafer 20 after completion of the stealth dicing process using the laser cutting machine 32 in step c); thereafter, in the step d) the to-be-removed portion 202 is broken at the second cutting location P2 and then removed along with the removal motion of the adhesive tape 40.

As described above, the method for dicing a wafer stack provided by the present invention uses the stealth dicing process performed by the laser cutting machine 32 to cut the first wafer 20 at second time to ensure that the to-be-removed portion 202 of the first wafer 20 won't fly off from the first wafer 20 during secondary cutting. In addition, the to-be-removed portion 202 can be conveniently removed by tweezers or an adhesive tape. In other words, the method for dicing a wafer stack of the present invention can effectively prevent the cutting equipment and/or semiconductor chips from hitting by cutting chips so as to enhance the package yield of the product.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for dicing a wafer stack, comprising the steps of:
a) providing a first wafer and a second wafer stacked under the first wafer;
b) cutting the first wafer by using a cutting blade to form a first cutting location on the first wafer;
c) cutting the first wafer by a stealth dicing process using a laser cutting machine to form a second cutting location on the first wafer in a way that the second cutting location is spaced from the first cutting location and a to-be-removed portion is defined between the first and second cutting locations;
d) removing the to-be-removed portion from the first wafer by breaking the to-be-removed portion at the second cutting location, and
e) cutting the second wafer by using the blade to form a plurality of chips.

2. The method of claim 1, wherein the first wafer is a MEMS wafer and the second wafer is a CMOS wafer.

3. The method of claim 1, wherein in the step d) the to-be-removed portion is broken by using tweezers to clamp an edge of the to-be-removed portion through the first cutting location and then bend the second cutting location upward.

4. The method of claim 1, further comprising a step of adhering an adhesive tape on a surface of the first wafer between the step b) and the step c); wherein in the step d) the to-be-removed portion is broken at the second cutting location by peeling off the adhesive tape from the first wafer in a way that the to-be-removed portion is bent at the second cutting location.

5. The method of claim 1, further comprising a step of adhering an adhesive tape on a surface of the first wafer between the step c) and the step d); wherein in the step d) the to-be-removed portion is broken at the second cutting location by peeling off the adhesive tape from the first wafer in a way that the to-be-removed portion is bent at the second cutting location.
